(19) United States
(12) Patent Application Publication
(10) Pub. No.: US 2018/0189338 A1
(43) Pub. Date: Jul. 5, 2018

(54) TECHNIQUES FOR ENHANCED PASTEBOARD USAGE

(71) Applicant: Google Inc., Mountain View, CA (US)

(72) Inventors: Dong Kim, Palo Alto, CA (US); Lirong Yuan, Palo Alto, CA (US)

(21) Appl. No.: 15/404,691

(22) Filed: Jan. 12, 2017

Related U.S. Application Data
(60) Provisional application No. 62/440,849, filed on Dec. 30, 2016.

(51) Int. Cl. G06F 17/30

(52) U.S. Cl. CPC G06F 17/30321; G06F 17/30345

(57) ABSTRACT

Techniques are described herein for reducing the number of inputs required by a user to utilize copied/cut content to perform various operations. In various implementations, it may be determined that new content has been added to a pasteboard data structure stored in memory of a computing device. The new content may be ready to be provided as input to one or more applications in response to a paste command. The new content may be analyzed to identify attribute(s) of the new content. Additionally or alternatively, dynamic attribute(s) of a state of the computing device may be identified. In various implementations, based on the attribute(s) of the new content and/or the dynamic attribute(s), candidate action(s) may be identified that are performable using the new content as input. Output may be generated and provided that is based the candidate action(s).

### BACKGROUND

Users often copy and/or cut content such as text, pictures, multimedia content, files, etc. to a so-called “pasteboard” (also referred to as a “clipboard”) so that the copied/cut content may be subsequently provided as input to one or more applications, in an operation commonly referred to as “pasting.” Content may be pasted into a variety of applications, such as productivity applications (e.g., word processing, spread sheets, presentation applications, media editing applications, etc.), web browsers (e.g., into input fields and/or address bars), file managers, communication applications (e.g., emails, text messages, messenger applications, etc.), and so forth. Users often cut/copy content from one location (e.g., an application, a portion of a document, a webpage, etc.) with the intent of performing some operation using the content as input. However, this may require the users to perform one or more additional operations, such as switching applications, pasting the content into another application or another location within the same application, and so forth, so that the user can perform the intended operation using the content as input. For example, user's commonly copy content from various locations, e.g., from a first application, and paste it into input fields of other applications, such as web browsers, e.g., to obtain responsive/related content, translate the content, convert the content to a different format, and so forth.

### SUMMARY

Techniques are described herein for reducing the number of inputs required by a user to utilize copied/cut content to perform various operations. This may benefit, for instance, users with reduced dexterity, whatever the cause, for which reducing the number of required inputs may benefit the user.

In various implementations, new content may be detected when it is added to a pasteboard data structure that is generally available across multiple applications executing on a computing device. Attributes of the new content may be analyzed to determine one or more candidate actions that may be performed by the computing device using the new content as input. Output may be provided based on the one or more candidate applications. The output may include automatic performance of some action using the new content as input, or it may include output such as a selectable list of candidate actions that may be performed using the new content as input.

In various implementations, a process (referred to below as a “pasteboard analyzer”) configured with selected aspects of the present disclosure may be a standalone application that operates on top of a third party computing environment/operating system, or a process that is a more integral part of a computing environment/operating system. In the former scenario, the application may not necessarily have permissions to access particular computing resources, such as an interrupt or other event associated with a copy or cut command. Accordingly, in some implementations, the standalone application may periodically (e.g., every 1 second) check the pasteboard data structure (assuming the data structure is accessible) for newly added content. If the pasteboard structure is not directly accessible, in some implementations, the standalone application may periodically (e.g., every one second) inquire (e.g., ping) a so-called “pasteboard manager” process that may, for instance, be part of the underlying operating system.

Once newly-copied/cut content is detected in the pasteboard data structure, one or more candidate actions may be identified based at least in part on one or more attributes of the new content. For example, suppose the newly copied/cut content includes text in a language that is different than other text recently input or consumed by a user using the computing device (e.g., in an email, message exchange thread, etc.). Candidate actions that may be applicable in such a scenario, such as a translation action, may be identified. Suppose the newly copied/cut content comprises a date or another piece of information that generally adheres to a known format (e.g., DD-MM-YYYY). Candidate actions that might be identified based on such content include creation of a new calendar entry (or modification of an existing calendar entry on the copied/cut date), creation of a new contact (e.g., if the copied/cut content matches a pattern associated with telephone numbers or email addresses), addition of payment information to an online wallet (e.g., if the copied/cut content matches a pattern associated with a credit card number), and so forth. Suppose the newly-copied/cut content is in a particular data format. Candidate actions that might be identified based on such an attribute may include applications that are designed to receive, as input, content in such a format.

Signals other than attributes of the newly copied/cut content may also be considered when identifying candidate actions. In some implementations, one or more so-called “dynamic attributes” of a state of the computing device may be identified and used to identify applicable candidate actions. Dynamic attributes of a state of a computing device may include attributes that tend to change over time, e.g., based on user operation of the computing device or otherwise, rather than static settings such as preferred language, preferred time zone, user preferences, and so forth (although static settings may be considered as well). Dynamic state attributes may include but are not limited to parameters such as a current time, a current location, applications currently running in the foreground/background of the computing device, calendar entries, past user actions with pasteboard content, a language currently being used by one or more participants in a message exchange thread, etc.

Once the candidate actions are identified, in various implementations, the computing device may provide output (e.g., visual, audio, etc.) that is based on the identified candidate actions. For example, in some implementations, a pull-down menu or list may be presented, with each entry being selectable to initiate a corresponding candidate action. In other implementations, visual output such as a pop up window, bubble, or even audible output may be provided that includes a translation of the content, a grammar-edited version of the content, suggested synonyms/antonyms, potential search results, and so forth. In some implementations, visual output may be provided that includes one or more so-called “deeplinks” that, when selected, launch (or otherwise make active) an application with at least one input field pre-populated with the copied/cut content. In some such implementations, those deeplinks may be presented as part of the aforementioned menu of selectable items. In yet other implementations, one or more candidate actions may be selected and initiated automatically. In some such implementations, automatic initiation may occur, for instance, where a log of past user actions involving similar copied/cut content indicates, e.g., with a threshold confidence, that the user is likely to initiate one or more candidate actions.

In some implementations, a method performed by one or more processors is provided that includes: determining that new content has been added to a pasteboard data structure stored in memory of a computing device, wherein the new content is ready to be provided as input to one or more applications in response to a paste command; analyzing the new content to identify one or more attributes of the new content; identifying one or more dynamic attributes of a state of the computing device; identifying, based on the one or more attributes of the new content and the one or more dynamic attributes, one or more candidate actions that are performable by one or more processors using the new content as input; and providing, via one or more output devices, output that is based the one or more candidate actions.

These and other implementations of technology disclosed herein may optionally include one or more of the following features.

In various implementations, the one or more dynamic attributes of the state of the computing device may not include user-defined settings or preferences. In various implementations, the determining may include periodically checking the pasteboard data structure for newly added content. In various implementations, the determining may include periodically inquiring with a pasteboard manager process. In various implementations, the determining may include detecting a copy or cut command.

In various implementations, the one or more dynamic attributes of the state of the computing device may include a position coordinate received from a position coordinate sensor, a current time, a foreground application that is currently operating on the computing device, one or more background applications that are currently operating on the computing device, one or more documents that are open on the computing device, and/or one or more calendar entries of an electronic calendar associated with the computing device.

In various implementations, the new content may include text in a first language, and the one or more candidate actions may include translation of the text to a second language. In various implementations, the one or more candidate actions may include obtaining a definition association with the new content, obtaining additional content related to the new content, performing a web search using the new content, and/or an application that is designed to receive, as input, content sharing the one or more attributes with the new content.

In another aspect, a method may include the following operations: inquiring, with a pasteboard manager process operating on the system, to detect when new content has been added to a pasteboard data structure stored in memory of the system, wherein the new content is ready to be provided as input to one or more applications in response to a paste command; analyzing the new content to identify one or more attributes of the new content; identifying, based on the one or more attributes of the new content, one or more candidate actions that are performable by the system using the new content as input; and providing, via one or more output devices, output that is based the one or more candidate actions.

In yet another aspect, a method may include: determining that new content has been added to a pasteboard data structure stored in memory of a computing device, wherein the new content is ready to be provided as input to one or more applications in response to a paste command; analyzing the new content to identify one or more attributes of the new content;

identifying a history of actions performed using one or more content items that share attributes with the new content; identifying, based on the one or more attributes of the new content and the history of actions, one or more candidate actions that are performable using the new content as input; and providing, via one or more output devices, output that is based the one or more candidate actions.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 is a block diagram of an example environment in which implementations disclosed herein may be implemented.

FIGS. 2, 3, 4, 5, and 6 depict example scenarios in which techniques described herein may be implemented, in accordance with various implementations.

FIG. 7 depicts an example process of practicing various techniques described herein.

FIG. 8 illustrates an example architecture of a computing device.

### DETAILED DESCRIPTION

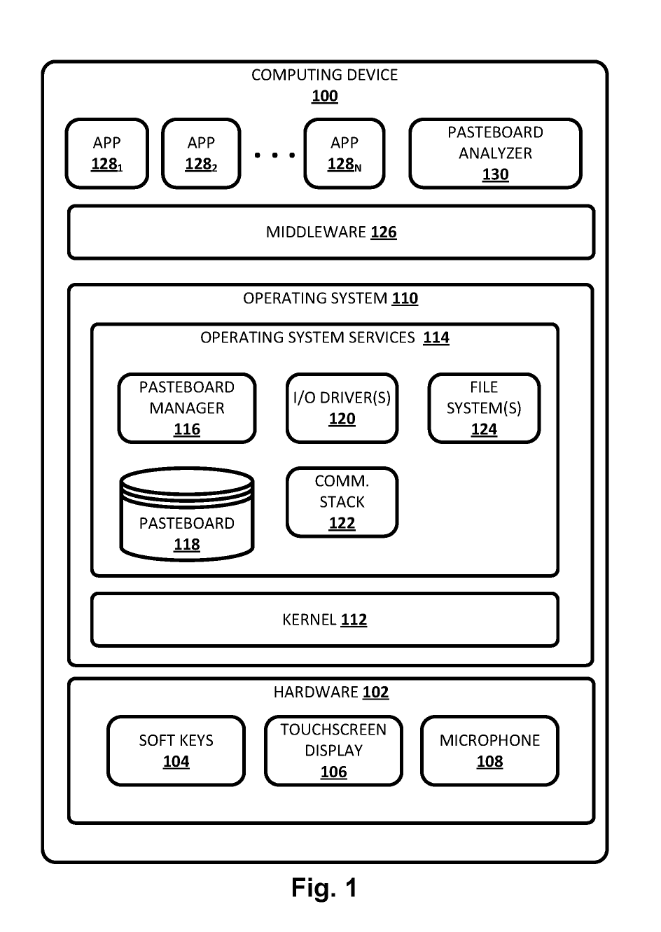

Now turning to FIG. 1, an example environment in which techniques disclosed herein may be implemented is illustrated. The example environment includes a computing device 100 configured with many conventional features commonly found in a hardware/software stack. Computing device 100 may come in a variety of forms, including but not limited to: a desktop computing device, a laptop computing device, a tablet computing device, a mobile phone computing device, a computing device of a vehicle of the user (e.g., an in-vehicle communications system, an in-vehicle entertainment system, an in-vehicle navigation system), and/or a wearable apparatus of the user that includes a computing device (e.g., a watch of the user having a computing device, glasses of the user having a computing device, a virtual or augmented reality computing device). Additional and/or alternative client computing devices may be provided.

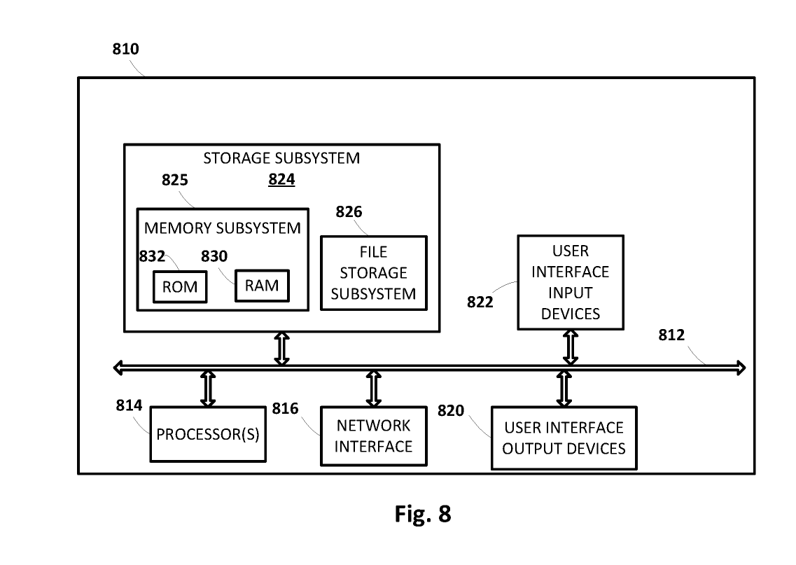

In addition to standard hardware such as one or more processors, memory, etc. (which are depicted in FIG. 8), computing device 100 may also various input and/or output hardware 102 such as one or more soft keys 104, a touchscreen 106, a microphone 108, and other components that are not depicted in FIG. 1, such as an accelerometer (e.g., to detect gestures/movement), one or more cameras (e.g., front-facing and/or rear facing), and so forth.

Computing device 100 may also include an operating system 110 that itself may include a kernel 112, as well as other services 114 that may be available to various software applications installed on computing device 100. For example, operating system services 114 may include a pasteboard manager process 116 (hereinafter referred to as a “pasteboard manager”) that controls access to a portion of memory (e.g., RAM) referred to herein as the “pasteboard” 118 (sometimes referred to as the “clipboard”) that is dedicated to at least temporary storage of content that is cut and/or copied from one or more software applications, with the purpose of later “pasting” it (e.g., providing it as input) to the same software application or a different software application.

Other operating system services 114 may include but are not limited to one or more hardware drivers, such as one or more input/output (“I/O”) drivers 120, a communication stack 122 (e.g., to control incoming and outgoing network communication through a network interface (not depicted)), one or more file systems 124 for controlling access to documents stored in volatile and/or non-volatile memory, and so forth. Computing device 100 may also include various types of middleware 126, which may serve as a bridge between operating system 110 and one or more software applications (“apps”) 128_{1-N}.

Software applications 128 may include various types of computer software, such as productivity applications (e.g., word processors, spreadsheets, etc.), web browsers, social media applications, email clients, media players, media editing applications, computer-aided design (“CAD”) software, presentation software, message exchange thread client such as text messaging applications, instant messaging applications, and so forth.

Also depicted in FIG. 1 is a software application taking the form of a pasteboard analyzer 130 that is configured with selected aspects of the present disclosure. In various implementations, pasteboard analyzer 130 may be configured to determine that new content has been added (e.g., copied, pasted) to a pasteboard data structure stored in pasteboard 118. In various implementations, the new content may be ready to be provided as input to one or more applications 128 in response to a paste command issued by a user of computing device 100. For example, a user may select one or more items from a drop down menu or other similar interface to “cut” or “copy” content from an application 128. Additionally or alternatively, a user may use another command to cut and/or copy content, such as a keyboard shortcut (e.g., ctrl-c or ctrl-x), a spoken command, a gesture, a context-driven drop-down menu (e.g., when a user selects text on a smart phone and holds a finger on the selected text), and so forth.

Cut or copied content may be added, e.g., by pasteboard manager 116, to a pasteboard data structure stored in pasteboard 118. The pasteboard data structure may take various forms, such as a stack, a first-in-first-out (“FIFO”) data structure such as a heap, and so forth. Copied/cut content may remain in pasteboard 118 for various time periods and/or until various events occur. For example, in some implementations, pasteboard 118 may be configured to at least temporarily store a particular number of content items. When new content is added (e.g., a user copies or cuts content from an application), the oldest content may be dropped (or “popped”). In other implementations, pasteboard 118 may store up to a predetermined amount of content, e.g., controlled by an amount of memory (e.g., RAM) allocated to pasteboard 118. In yet other implementations, the amount of content that may be at least temporarily stored in pasteboard 118 may be set, e.g., by a user or automatically depending on the circumstances. In some implementations, pasteboard 118 may be cleared upon a reboot of computing device 100, although this is not required, and in other implementations, contents of pasteboard 118 may be persisted in non-volatile memory and reloaded to volatile memory once computing device 100 restarts.

In various implementations, pasteboard analyzer 130 may be configured to determine that new content has been added to pasteboard 118 in various ways. In some implementations, such as that depicted in FIG. 1, pasteboard analyzer 130 executes at the application level (e.g., in user space), e.g., as an application that is installed “on top of” operating system 110. Consequently, pasteboard analyzer 130 may not necessarily have direct access to pasteboard 118, e.g., because it lacks sufficient permissions/privileges, and/or may not have direct access to cut and/or copy events when they occur. Instead, pasteboard analyzer 130 may periodically check pasteboard 118 for newly added content. For example, in some implementations, pasteboard analyzer 130 may periodically inquire with pasteboard manager 116, e.g., by sending pasteboard manager 116 a “ping” every so often (e.g., every second, or some other time interval). To reduce power consumption, in some such implementations, pasteboard analyzer 130 may only send such inquiries when computing device 100 is “active,” e.g., when a user is actively providing input and/or receiving output, has the screen unlocked, etc. If computing device 100 is current “inactive,” e.g., in sleep mode, locked, hasn't received input within a predetermined time interval, etc., then pasteboard analyzer 130 may refrain from sending pasteboard manager 116 such inquiries to conserve power.

In other implementations, pasteboard analyzer 130 may be installed at a “lower level,” e.g., in system space as part of middleware 126 or even operating system 110. Additionally or alternatively, pasteboard manager 116 itself may be configured with selected aspects of the present disclosure (i.e. those aspects generally attributed herein to pasteboard analyzer 130), and a distinct pasteboard analyzer 130 may be omitted. Whichever the case, in such implementations, pasteboard analyzer 130 (or pasteboard manager 116 as the case may be) may be configured to detect a copy or cut event in real time, e.g., in response to an interrupt or other similar event caused by a user operating one or more input components to provide a cut or copy command.

However pasteboard analyzer 130 detects that new content has been added to pasteboard 118, in various implementations, pasteboard analyzer 130 may be configured to analyze the newly-added content to determine various attributes of the newly-added content. Various types of content may be copied/cut and added to pasteboard 118, including but not limited to text, images, video, files, audio files, animations, designs, communications (e.g., emails), documents, and/or a combination thereof. Accordingly, through its analysis, pasteboard analyzer 130 may determine various attributes of the newly-added content. For example, if the copied/cut content includes text, pasteboard analyzer 130 may determine a language of the text, a “tone” of the text (e.g., formal, informal, boilerplate, etc.), whether the text is copied from a known source (e.g., a known work of literature), an author of the text (e.g., the user that typed it, another user who typed it), a network resource identifier (e.g., a uniform resource locator, or “URL”) of a network resource (e.g., a webpage) from which the text was copied/cut, an application from which the text (or more generally, the content) was copied/cut, a format of the copied/cut content (e.g., text versus image, etc.) and so forth.

In some implementations, pasteboard analyzer 130 (or another component of computing device 100) may be configured to identify, in addition to or instead of the aforementioned attributes of the copied/cut content, one or more dynamic attributes of a state of computing device 100. As noted above, dynamic attributes of a state of computing device 100 may include attributes that tend to change over time, e.g., based on user operation of computing device 100 or otherwise, rather than static settings such as preferred language, preferred time zone, user preferences (e.g., user-set language), and so forth (although static settings may be considered as well). Dynamic state attributes may include but are not limited to parameters such as a current time, a current location, applications currently running in the foreground/background of the computing device, calendar entries, past user actions with pasteboard content, a language currently being used by one or more participants in a message exchange thread, etc.

In various implementations, and based on the attributes of the newly-added (i.e., cut or copied) content and/or based on the one or more dynamic attributes of the state of computing device 100, pasteboard analyzer 130 may identify one or more candidate actions that are performable by computing device 100 using the newly-added content as input. Candidate actions may include a wide variety of processes, applications, macros, or other routines that may be performed by computing device 100 using the copied/cut content as input.

As a simple example, suppose a user operating a web browser executing on computing device 100 highlights a portion of a webpage's text and issues a copy command (e.g., ctrl-c, menu-based command, spoken command, gesture, etc.). The highlighted text may be added to pasteboard 118 and then analyzed to determine that, for instance, the copied text is in German. Pasteboard analyzer 130 may then determine that most of the websites browsed by the user (e.g., recently, over a longer period of time, etc.) are in English. Additionally or alternatively, pasteboard analyzer 130 may determine, e.g., from one or more user preferences settings, e.g., within operating system 110, that the user's preferred language is English. Whichever the case, pasteboard analyzer 130 may determine from these signals that one candidate responsive action that may be suitable is translation of the copied text to English. Such a translation process may be implemented locally at computing device 100 and/or remotely, e.g., as one or more web services that form what may be referred to as the “cloud.”

In various implementations, pasteboard analyzer 130 (or another component of computing device 100) may provide, or cause to be provided, via one or more output devices, output that is based the one or more candidate actions. For example, in the above-described example, a pop up window or contextual menu may appear (or be queued up to appear in response to an additional user command). The user may then be able to select and/or initiate one or more responsive candidate actions that are identified by pasteboard analyzer 130 based on the attributes of the copied text and/or dynamic attributes of a state of computing device 100.

In other implementations, one or more candidate tasks may be automatically initiated, e.g., by or at the request of pasteboard analyzer 130, based on its analysis of the copied/cut content and/or the dynamic attribute(s) of computing device 100. For example, in some implementations, a history of user interaction with various types of copied/cut content may be maintained, e.g., locally at computing device 100 (in which case the history may include local user interaction with various types of copied/cut content) or remotely (in which case the history may include local user interaction with various types of copied/cut content, and/or a history of interaction by a plurality of users with various types of copied/cut content). In some implementations, a history of a particular user's interaction with copied/cut content may be stored across a plurality of computing devices operated or otherwise controlled by the particular user, which may include a coordinated “ecosystem” of devices (e.g., smart phones, smart watches, standalone smart speakers, etc.). Whichever the case, in various implementations, if it is determined that a user (or a plurality of users) tends to initiate a particular responsive action when the user cuts and/or copies a particular type of content (e.g., under a particular set of circumstances determined from dynamic state attributes), that responsive action may be performed automatically. If the automatic performance does not comport with a user's intent, the user may provide negative feedback, in which case the responsive action may not be automatically performed in the future, at least insofar as the particular user is concerned.

In addition to or instead of the example candidate responsive actions described above, in various implementations, other candidate responsive actions may be identified based on one or more of attribute(s) of the copied/cut content and/or dynamic attributes of the state of computing device 100. In some implementations, e.g., where the copied/cut content includes a word or phrase, one candidate responsive action may be to obtain a definition association with the copied/cut content. For example, the copied/cut word/phrase may be provided to a dictionary website and/or web service, which may provide and/or return one or more definitions, synonyms, antonyms, example usages, etc. Additionally or alternatively, in some implementations, the candidate responsive actions may include obtaining additional content related to the copied/cut content. For example, a web search may be performed (or provided as a user-selectable option) using the copied/cut content.

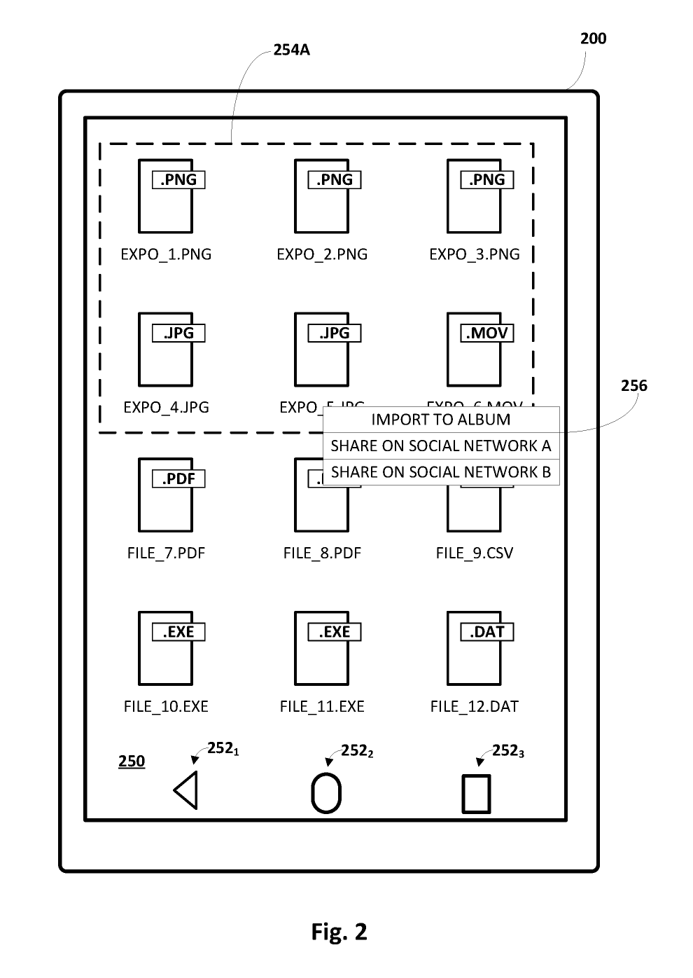

In yet other implementations, the candidate responsive action may include an application that is designed to receive, as input, content sharing one or more attributes with the newly-copied/cut content. Referring now to FIG. 2, a computing device 200 in the form of a smart phone or tablet that is configured with selected aspects of the present disclosure includes a touchscreen 250 and one or more soft keys 252₁₋₃. Currently displayed on touchscreen 250 is a plurality of icons representing various documents of various types. Thus, what is depicted may represent a graphical user interface associated with a file manager application that enables a user to select one or more files and perform various actions with those files, such as renaming, deleting, opening, moving, etc.

Selection box 254A depicts one example of how a user may select multiple documents/files at once for various purposes, and how techniques described herein may be utilized to analyze copied/cut content and identify candidate actions to perform based on attributes of the copied/cut content. In this example, the files selected are one of three types: .PNG files, .JPG files, and .MOV files. All three selected file types are associated with file formats that can be opened and visually viewed. For instance, .JPG files and .PNG files may be formats used to store digital photographs or other visual works. .MOV files also may store visual content, e.g., in the form of a series of images, in combination with audible content. Suppose further that upon drawing selection box 254A to select these files, a user issues a cut or copy command. In some implementations, pasteboard analyzer 130 may determine that these files share various attributes in common, such as visual content. Additionally or alternatively, pasteboard analyzer 130 may determine other shared attributes of the files, e.g., from associated metadata, such as their filenames, time created, time modified, author, etc. In this example, the files selected by selection box 254A all share the common filename prefix “EXPO” (e.g., suggesting they were captured at some sort of exposition or conference).

Based on one or more of these shared attributes, pasteboard analyzer 130 may select one or more candidate actions that may be performable with these copied/cut files (or data such as handles indicative thereof) stored in pasteboard 118. For example, a user could use such files (e.g., as input) to create an electronic photo album, e.g., for a webpage or social network. Thus, when the user copies or cuts the files contained in selection box 254A, the user may be provided with output, e.g., such as dropdown menu 256, which provides the user with selectable options that are determined based on attributes shared among the copied/cut files. In some implementations, dropdown menu 256 (or other similar output such as popup windows, etc.) may appear in response to the user providing the cut/copy command (whether actually in response to the command itself to in response to periodic inquiry by pasteboard analyzer 130). In this example, the options presented are “IMPORT TO ALBUM,” “SHARE ON SOCIAL NETWORK A,” and “SHARE ON SOCIAL NETWORK B.” Depending on which option the user selects, a corresponding action may be performed. It is worth mentioning that the file manager application that is displayed in FIG. 2 may not necessarily have any direct connection or affiliation with these candidate actions.

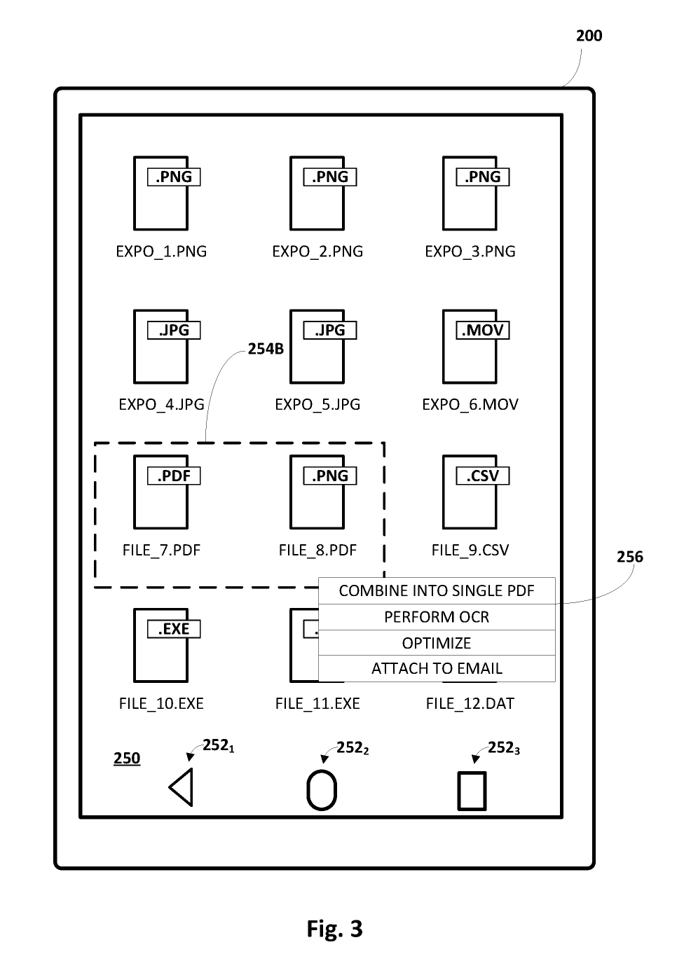

In FIG. 3, the same computing device 200 is depicted, with the same graphical user interface associated with the file manager still active. In this example, however, two portable document format (“PDF”) files are selected by a different selection box 254B, and have been cut or copied (the files themselves or handles indicative thereof) to pasteboard 118. Consequently, pasteboard analyzer 130 may identify and present a completely different set of responsive actions in dropdown menu 256. In this case, the user is presented with the options of combining the copied/cut PDF files into a single file, performing optical character recognition (“OCR”) on the files, optimizing the files (e.g., reducing their sizes, e.g., for email purposes), and attaching the files to an email to be sent.

As noted above, in various implementations, the candidate responsive actions may be identified based on signals other than attributes of the copied/cut content itself. For example, in FIG. 3, the “ATTACH TO EMAIL” option may be presented because a dynamic attribute of the current state of computing device 200 may be that another application, such as an email application, is currently running in the background. Additionally or alternatively, the “IMPORT TO ALBUM” option in FIG. 2 may be presented at least in part because the user currently has a multimedia album application operating in the background of computing device 200. In some implementations, if that multimedia album application were not currently running in the background, that option might not be presented.

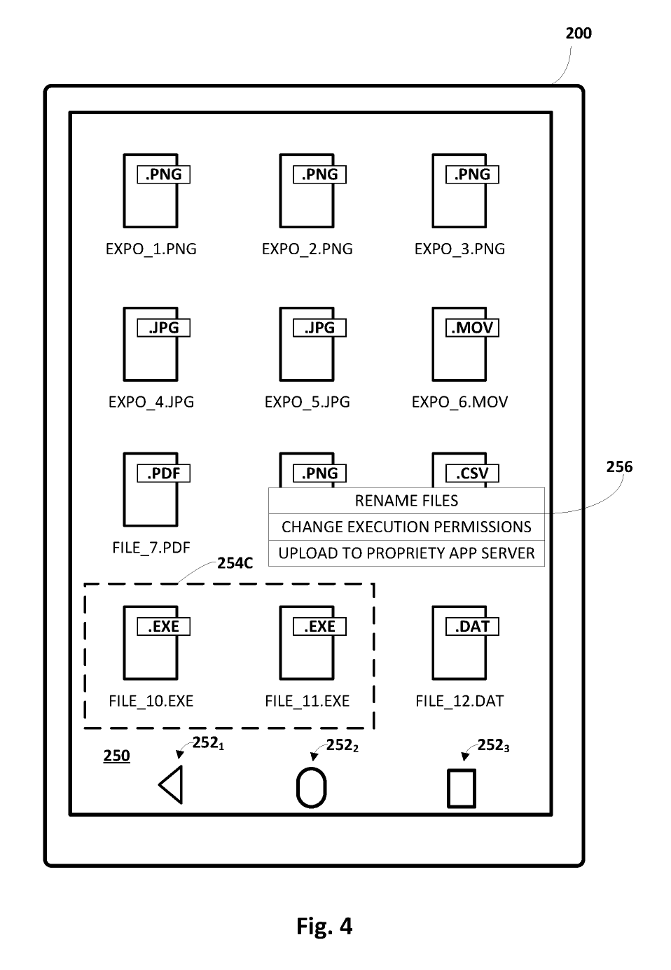

As another example, in FIG. 4, the same computing device 200 is depicted, with the same graphical user interface associated with the file manager being active. In this example, however, assume the user has carried computing device 200 into work at a software company. Suppose also that the user has selected and copied the executable files captured in selection box 254C. Because the user is at work—which may in some implementations be determined from a position coordinate received from a position coordinate sensor (e.g., Global Positioning System, or “GPS,” Wi-Fi access point location, triangulation, etc.) integral with computing device 200 or elsewhere—the user may be presented with options that are applicable only at that location. For example, in FIG. 4, the options presented to the user are: “RENAME FILES,” “CHANGE EXECUTION PERMISSIONS,” and “UPLOAD TO PROPRIETARY APP SERVER.” Some of the options, such as the first two, may be selected wholly or at least partially on attributes of the copied/cut files (e.g., they are all executable files). The third option, however, may only be available because pasteboard analyzer 130 determined that a dynamic attribute of a state of computing device 200 is that it is located at the software company's facility, and thus is able to upload executable files to the PROPRIETARY APP SERVER.

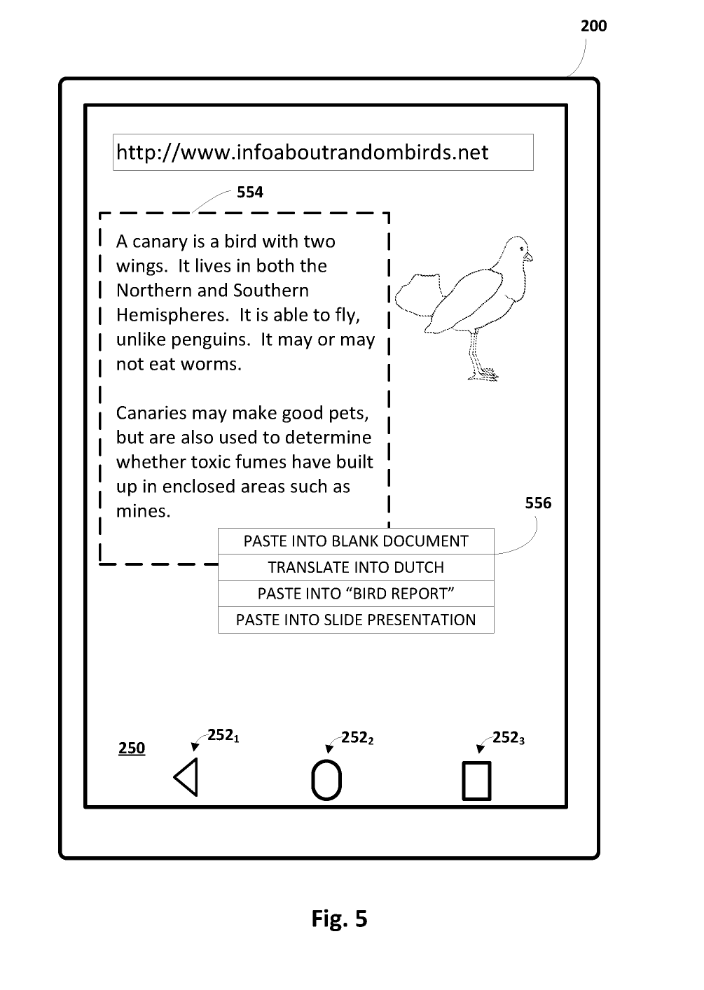

FIG. 5 depicts an alternative scenario to that depicted in FIGS. 2-4. In FIG. 5, the computing device 200 is being used to visit a webpage about canaries. A selection box 554 has been drawn to select text displayed on the webpage. In response to a user issuing a copy command (“cut” may not be available on a “read only” document such as a webpage), a dropdown menu 556 appears with the following options: “PASTE INTO BLANK DOCUMENT,” “LOOK UP RELATED BIRDS,” “PASTE INTO ‘BIRD REPORT’,” and “PASTE INTO SLIDE PRESENTATION.” The first option, “PASTE INTO BLANK DOCUMENT,” may be a relatively generic candidate action that may be provided, for instance, whenever a user copies/cuts text from any location. “TRANSLATE INTO DUTCH” may be made available because, for instance, the user often uses the Dutch language to communicate with others, e.g., using email, texting, etc., and/or because a user setting indicates the user's preferred language is Dutch. If the user selects that option, in some implementations, a popup window may appear with a Dutch translation of the text. Additionally or alternatively, in some implementations, a Dutch translation of the text may be added to pasteboard 118, e.g., as a newest item that is ready to be pasted.

“PASTE INTO ‘BIRD REPORT’” may be made available because, for instance, the user may be currently working on (in the background of computing device 200), or may have recently worked on, a document with the filename “BIRD REPORT,” or with a title or other metadata that includes “BIRD REPORT.” For example, the copied textual content may be analyzed semantically to determine that it relates to birds. This semantic analysis may lead to a match with a file, “BIRD REPORT,” that the user has recently been drafting. The semantic match may be based on the copied content, content of the targeted document, and/or metadata related to the targeted document.

“PASTE INTO SLIDE PRESENTATION” may be made available because the user currently has a slide presentation editor open, e.g., in the background. In some implementations, had the user copied the image of the bird in addition to the text, then options such as “TRANSLATE INTO DUTCH” may or may not appear because the copied content includes an image incapable of translation. Similarly, if the “BIRD REPORT” is a text-only document, then the translation option may not be made available if the user copies the image of the bird in addition to or instead of the text.

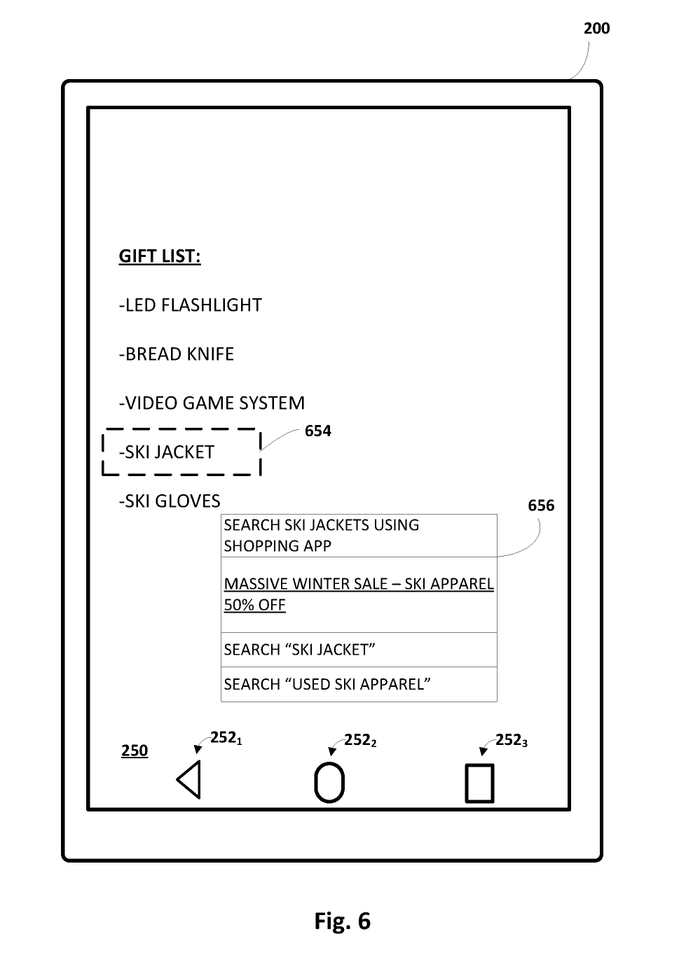

FIG. 6 depicts yet another example of how techniques described herein may be used to analyze and present output based on copied/cut text stored at least temporarily in pasteboard 118. In FIG. 6, computing device 200 is being used to view/edit a gift list. A selection box 654 has been drawn around the item, “SKI JACKET,” and the user has issued a copy or cut command. A dropdown menu 656 is presented that includes the following options: “SEARCH SKI JACKETS USING SHOPPING APP,” “MASSIVE WINTER SALE—SKI APPAREL 50% OFF,” “SEARCH ‘SKI JACKET’,” and “USED SKI APPAREL.” The first option may be a so-called “deep link” that is selectable to cause a “SHOPPING” app installed on computing device 200 to be launched or otherwise made active (e.g., brought to the foreground of computing device 200). One or more inputs of the shopping app may be prepopulated with the copied phrase “SKI JACKET.” In some implementations, the shopping app may have already submitted the phrase as a search query, e.g., on a general search engine or a search engine specifically associated with the shopping app. Accordingly, the second option may include a hyperlink to a network resource, e.g., a webpage, that announces a sale on winter apparel. The third option may, if selected, cause a general search engine search for the copied text. The fourth option may include an alternative query suggestion that, if selected, causes a general search engine search to be submitted with the alternative query suggestion.

In other implementations, other (e.g., older) content of the pasteboard data structure stored in pasteboard 118 may be considered, e.g., by pasteboard analyzer 130, when identifying candidate actions. Suppose the newly-copied/cut content shares attributes with one or more previously-copied/cut content items still available in the pasteboard data structure. In some implementations, one or more candidate actions that involve using multiple content items in the pasteboard data structure as input may be identified. For example, if multiple audio files stored in the pasteboard data structure, a candidate action may be to create a playlist with the multiple audio files. If multiple photographs are stored in the pasteboard data structure, a candidate action may be to create an album with the photographs, and/or to post the photographs to social media or other destinations.

In yet other implementations, a user's (or users in the aggregate) past interaction with copied/cut content that is similar to (e.g., shares attributes with) the most recently-copied/cut content may be used to identify one or more candidate actions. For example, suppose a user is updating his or her contacts, e.g., from a phone list document. Suppose each time the user copies a person's name and telephone number from the phone list, the user creates manually a new contact or edits an existing contact to include the copied information. In various implementations, after a sufficient number of instances of this occurring, the user may be prompted, e.g., in response to copying a new name and telephone number, whether she wishes to create/edit a contact matching the copied name.

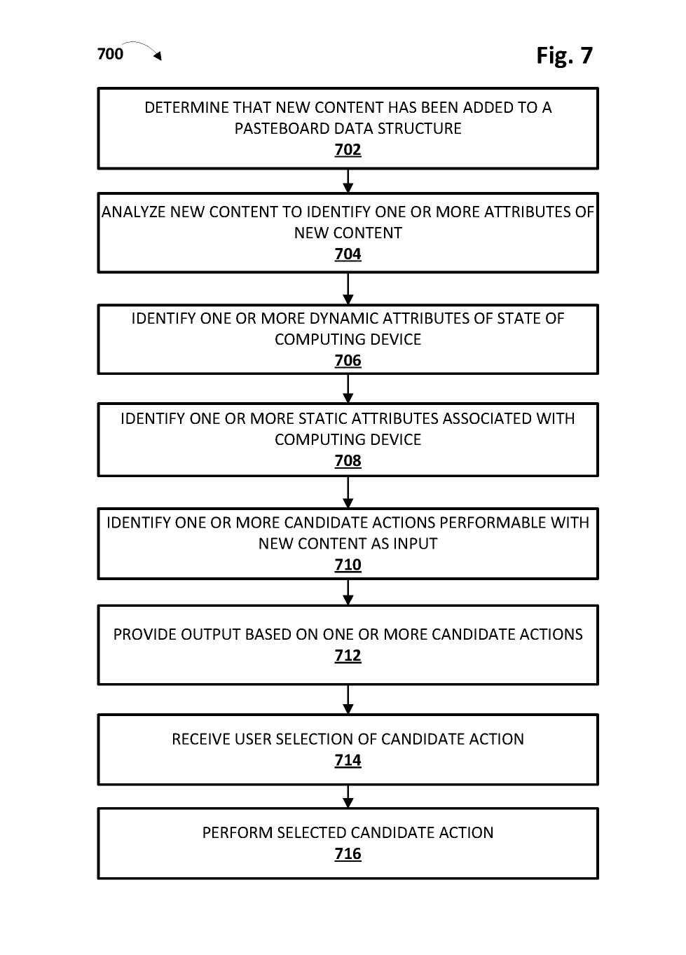

FIG. 7 is a flowchart illustrating an example method 700 according to implementations disclosed herein. For convenience, the operations of the flow chart are described with reference to a system that performs the operations. This system may include various components of various computer systems, such as one or more components depicted in FIG. 1, including pasteboard manager 116, pasteboard 118, and/or pasteboard analyzer 130. Moreover, while operations of method 700 are shown in a particular order, this is not meant to be limiting. One or more operations may be reordered, omitted or added.

At block 702, the system may determine that new content has been added to a pasteboard data structure stored in a pasteboard-designated portion of memory. As noted above, if techniques described herein are performed at least in part by a user-space application such as pasteboard analyzer 130, then in some instances, this determination may be made by periodically inquiring with a pasteboard management process (e.g., pasteboard manager 116), e.g., every one second, two seconds, etc. By contrast, if techniques described herein are performed by components have greater privileges, e.g., native components or components of middleware or an operating system, then those components may have greater permissions and direct access to events such as cut/copy commands.

At block 704, the system may analyze the new content to identify one or more attributes of the new content. As noted above, these attributes may include, but are not limited to, semantic attributes of the content, a language of the content, a format of the content, metadata associated with the content, and so forth. These attributes may also include attributes such as an application from which the content was copied/cut, a size of the content, a number of n-grams in textual content, and so forth.

At optional block 706, the system may identify one or more dynamic attributes associated with a state of the computing device. For instance, the system may identify a geographic location of the computing device (e.g., including a local time zone), a time of day, a version of software (e.g., application, operating system, etc.) operating on the computing device, input and/or output devices available to the computing devices (e.g., paired Bluetooth peripherals, connected devices, etc.), one or more wired or wireless networks currently available to the computing device, an amount of battery power available to the computing device, one or more applications currently operating in the foreground/background of the computing device, an interaction history of the user (e.g., what apps and processes has the user run in the last few hours/days/week), what permissions the user has granted each application (e.g., permission to access photos, calendar, email, etc.), and so forth. Dynamic state attributes may also include data points such as calendar entries, incoming/outgoing communications (e.g., emails, text messages, etc.), reminders, task lists, shopping lists, and so forth.

At block 708, the system may identify one or more static attributes associated with the computing device. These may include, for instance, user preferences such as language preference, time zone, keyboard layout preferences, user settings related to automated assistants, installed application, static settings associated with installed applications, and so forth.

At block 710, the system may identify one or more candidate actions that may be performable with the newly-copied/cut content as input. Various examples of candidate actions that may be identified are described. Other candidate applications may also be identified. For example, suppose a user has a calendar entry that indicates the user is going to meet with another person at a particular time and/or place. If the user copies/cuts text or other content associated with the particular place at which the user is scheduled to meet, candidate actions may include, for instance, pasting the copied content into a message (e.g., email, text message, etc.) addressed to the other person, e.g., that the user can notify the other person of information about the location. As another example, suppose a user copies text from a webpage about a particular product brand. If there is a similar entry in the user's shopping list about a product of the same type (or a reminder set to purchase a product having the same type), a candidate action may be to update that item in the user's shopping list to add the particular copied brand into the item of the shopping list. Of course, virtually endless other possibilities are possible.

At block 712, the system may provide output based on the one or more candidate actions identified at block 710. For example, a pop up window and/or drop down menu with the candidate actions may be presented, so that the user is able to select which action to initiate, as described above. Additionally or alternatively, the user may be provided with audible output, e.g., from an automated assistant, asking the user if they would like to perform particular candidate actions using the copied/cut content as input. Or, as noted, above, in some implementations, the system may automatically perform some candidate action, e.g., where a confidence that the candidate action is what the user intends satisfies some threshold.

At block 714, the system may receive user selection of a candidate action. For example the user may select one or more menu options of a pull down menu, as described above. Additionally or alternatively, the user may provide spoken input indicate which of a list of present candidate actions should be performed using the copied/cut content as input. Or, if the system automatically performs the candidate action, the user may not be provided with explicit output (although they may have an opportunity to provide positive/negative feedback after the fact). At block 716, the system may perform the selected candidate action.

FIG. 8 is a block diagram of an example computing device 810 that may optionally be utilized to perform one or more aspects of techniques described herein. In some implementations, one or more of a client computing device, pasteboard analyzer 130, pasteboard manager 116, and/or other component(s) may comprise one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of the method of FIG. 7, as well as to implement various components depicted in FIG. 1.

These software modules are generally executed by processor 814 alone or in combination with other processors. Memory 825 used in the storage subsystem 824 can include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814. Bus subsystem 812 provides a mechanism for letting the various components and subsystems of computing device 810 communicate with each other as intended. Although bus subsystem 812 is shown schematically as a single bus, alternative implementations of the bus subsystem may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In situations in which certain implementations discussed herein may collect or use personal information about users (e.g., user data extracted from other electronic communications, information about a user's social network, a user's location, a user's time, a user's biometric information, and a user's activities and demographic information), users are provided with one or more opportunities to control whether information is collected, whether the personal information is stored, whether the personal information is used, and how the information is collected about the user, stored and used. That is, the systems and methods discussed herein collect, store and/or use user personal information only upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method, comprising:
determining, by one or more processors, that new content has been added to a pasteboard data structure stored in memory of a computing device, wherein the new content is ready to be provided as input to one or more applications in response to a paste command;
analyzing, by one or more of the processors, the new content to identify one or more attributes of the new content;
identifying, by one or more of the processors, one or more dynamic attributes of a state of the computing device;
identifying, by one or more of the processors, based on the one or more attributes of the new content and the one or more dynamic attributes, one or more candidate actions that are performable by the one or more processors using the new content as input; and
providing, by one or more of the processors, via one or more output devices, output that is based the one or more candidate actions.

2. The computer-implemented method of claim 1, wherein the one or more dynamic attributes of the state of the computing device do not include user-defined settings or preferences.

3. The computer-implemented method of claim 1, wherein the determining comprises periodically checking the pasteboard data structure for newly added content.

4. The computer-implemented method of claim 1, wherein the determining comprises periodically inquiring with a pasteboard manager process.

5. The computer-implemented method of claim 1, wherein the determining comprises detecting a copy or cut command.

6. The computer-implemented method of claim 1, wherein the one or more dynamic attributes of the state of the computing device include a position coordinate received from a position coordinate sensor.

7. The computer-implemented method of claim 1, wherein the one or more dynamic attributes of the state of the computing device include a current time.

8. The computer-implemented method of claim 1, wherein the one or more dynamic attributes of the state of the computing device include a foreground application that is currently operating on the computing device.

9. The computer-implemented method of claim 1, wherein the one or more dynamic attributes of the state of the computing device include one or more background applications that are currently operating on the computing device.

10. The computer-implemented method of claim 1, wherein the one or more dynamic attributes of the state of the computing device include one or more documents that are open on the computing device.

11. The computer-implemented method of claim 1, wherein the one or more dynamic attributes of the state of the computing device include one or more calendar entries of an electronic calendar associated with the computing device.

12. The computer-implemented method of claim 1, wherein the new content comprises text in a first language, and the one or more candidate actions include translation of the text to a second language.

13. The computer-implemented method of claim 1, wherein the one or more candidate actions include obtaining a definition association with the new content.

14. The computer-implemented method of claim 1, wherein the one or more candidate actions include obtaining additional content related to the new content.

15. The computer-implemented method of claim 1, wherein the one or more candidate actions include performing a web search using the new content.

16. The computer-implemented method of claim 1, wherein the one or more candidate actions include an application that is designed to receive, as input, content sharing the one or more attributes with the new content.

17. A system comprising one or more processors and memory operably coupled with the one or more processors, wherein the memory stores instructions that, in response to execution of the instructions by one or more processors, cause the one or more processors to:
inquire, with a pasteboard manager process operating on the system, to detect when new content has been added to a pasteboard data structure stored in memory of the system, wherein the new content is ready to be provided as input to one or more applications in response to a paste command;
analyze the new content to identify one or more attributes of the new content;
identify, based on the one or more attributes of the new content, one or more candidate actions that are performable by the system using the new content as input; and
provide, via one or more output devices, output that is based the one or more candidate actions.

18. The system of claim 17, further comprising instructions to periodically inquire with the pasteboard manager process to detect when new content has been added to the pasteboard data structure.

19. At least one non-transitory computer-readable medium comprising instructions that, in response to execution of the instructions by one or more processors, cause the one or more processors to perform the following operations:
determining that new content has been added to a pasteboard data structure stored in memory of a computing device, wherein the new content is ready to be provided as input to one or more applications in response to a paste command;
analyzing the new content to identify one or more attributes of the new content;
identifying a history of actions performed using one or more content items that share attributes with the new content;
identifying, based on the one or more attributes of the new content and the history of actions, one or more candidate actions that are performable using the new content as input; and
providing, via one or more output devices, output that is based the one or more candidate actions.

20. The at least one non-transitory computer-readable medium of claim 19, wherein the determining comprises periodically checking the pasteboard data structure for newly added content.
